(19) United States
(12) Patent Application Publication
(10) Pub. No.: US 2014/0188988 A1
(43) Pub. Date: Jul. 3, 2014

(54) ACCESS CONTROLLED PROFESSIONAL SOCIAL NETWORK SYSTEM

(71) Applicant: Michael D. Kane, Naples, FL (US)

(72) Inventor: Michael D. Kane, Naples, FL (US)

(21) Appl. No.: 13/727,670

(22) Filed: Dec. 27, 2012

(51) Int. Cl. H04L 29/06

(52) U.S. Cl. CPC H04L 29/06
USPC 709/204

(57) ABSTRACT

A professional social network system comprises selecting between a first area and a second area, displaying a registration component to register a member account, accepting input through an attestation component, validating the identity component provided through the attestation component and registering a member through a registration component.

### FIELD OF TECHNOLOGY

This disclosure relates generally to professional social networks and, more particularly, to professional networks having access restrictions based on validation of identity.

### BACKGROUND

Social networks have become a large and significant part of human life. Social networks create a virtual world where people can meet without the restrictions of physical location and hassles of travelling.

Presently, social networks are increasingly used by users for various specific needs. Social networks help in meeting people who share interests from without restriction to physical boundaries and distances.

### SUMMARY

Disclosed are a method, an apparatus and/or a system of an access controlled professional social network. In one aspect, a professional social network system comprises one or more processors, memory and one or more programs The one or more programs are stored in the memory and configured to be executed by the one or more processors. In one aspect, the programs include instructions for selecting between a first area and a second area. The programs further include instructions for displaying a registration component to register a member account. Still further, the programs include instructions for accepting input through an attestation component, and instructions for validating the identity component provided through the attestation component. The programs also include instructions for registering a member through a registration component.

In another aspect, the first area may be a real identity area and the second area may be an anonymous user area.

In another aspect, the verification component may access one or more websites hosted at a server through a computer network to verify the identity validation.

In yet another aspect, the programs may include instructions to create discussion platforms and instructions to include new member accounts.

In a further aspect the programs may include instructions to create discussion platforms by accepting inputs from member accounts. and instructions for adding an another member account.

In another aspect, a computer-implemented method of a professional social network system comprises of selecting between a first area and a second area, displaying a registration component to register a member account, accepting input through an attestation component, validating the identity component provided through the attestation component and registering a member through a registration component.

In another aspect, the first area may be a real identity area and the second area is an anonymous user area.

In another aspect, the verification component may access one or more websites hosted at a server through a computer network to verify the identity validation.

In yet another aspect, the programs may include instructions to create discussion platforms, instructions to include new member accounts and instructions to create discussion platforms by accepting inputs from member accounts.

In further aspect the programs may further include instructions for adding an another member account.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a professional social network system, according to one or more embodiments.

FIG. 2 is a process flow diagram detailing the operation of a professional social network system, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of multi-platform content streaming. Although the present embodiments have been described with reference to specific example embodiments, it will be evident that various modifications and changes may be made to these embodiments without departing from the broader spirit and scope of the various embodiments.

In one or more embodiments, a professional social network may be a computer network based social network that is a service and/or a platform. A social network may be an online service and/or platform that facilitate building social relations amongst users of the social network.

In an example embodiment, a user may access a link to a website that hosts a professional social network. The user may be prompted to register on the website. Registration on the website may be seeking permission to access the professional social network. To complete registration the user may have to provide documents to validate identity. Documents requested from the user may relevant to one of identity, address, profession, professional registration, and/or affiliation.

In one or more embodiments, the professional social network registration may include a registration component and an attestation component. The registration component may seek and collect details and/or documents of users that are necessary for the attestation component. The attestation component may validate the details and/or documents provided by the users.

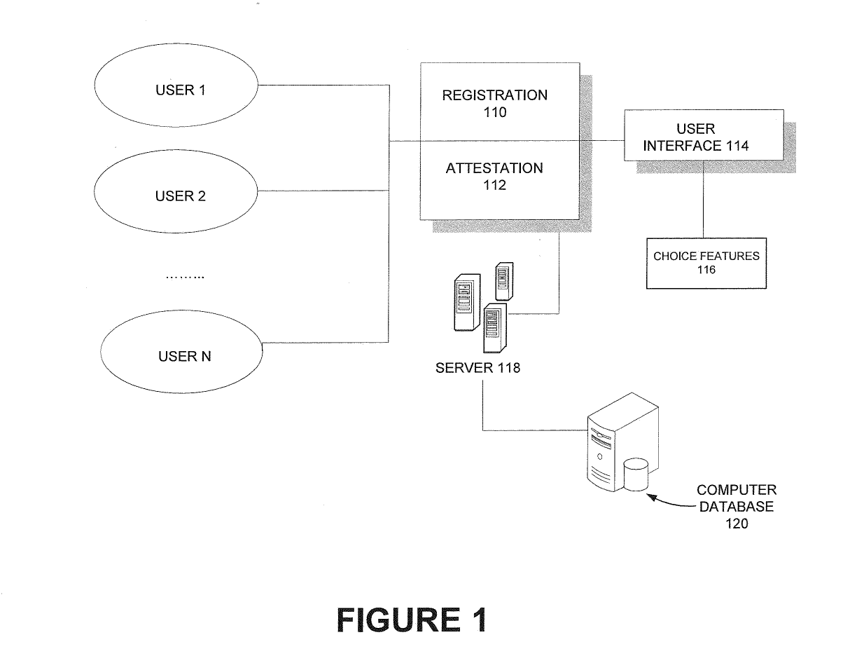

FIG. 1 shows a professional social network system, according to one or more embodiments. The professional social network system may include users₁₋ₙ. Users₁₋ₙ may access a website through a computer network. Users₁₋ₙ are directed to a registration component 110 that may be coupled to an attestation component 112. The registration component 110 and the attestation component 112 may be coupled to a server 118. The server 118 may be coupled to computer database 120. The professional social network further includes a user interface 114 that may allow Users₁₋ₙ to access and/or use the professional social network. The user interface 114 may include additional features 116. additional features 116 may include one of creating discussion platforms, adding new users, suggesting new users to invite onto the professional social network, and/or upgrading account to superior access.

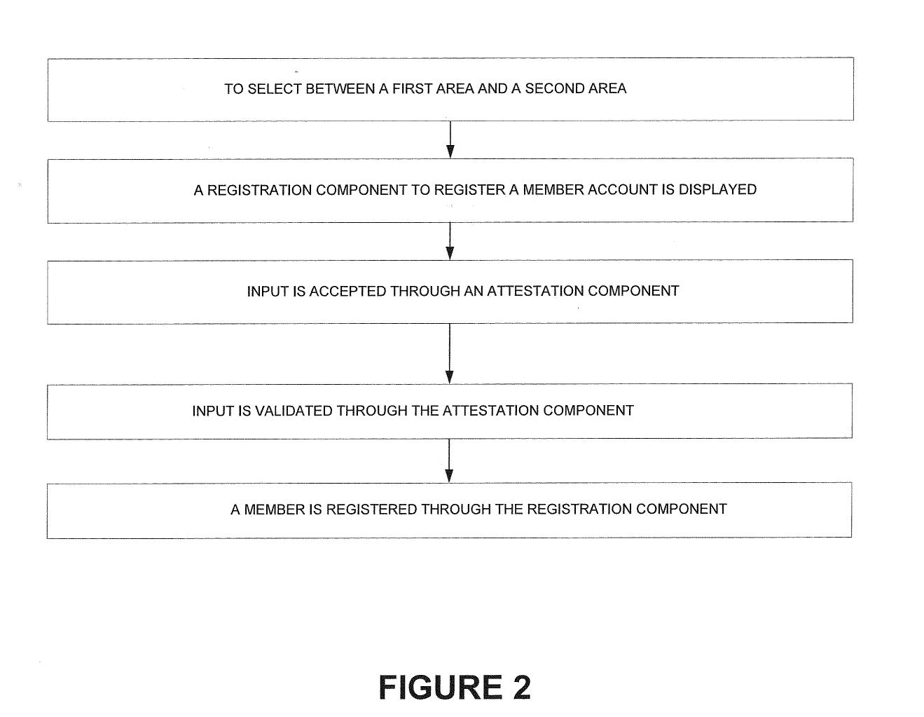

FIG. 2 shows a process flow diagram detailing the operations involved in a method of a professional social network system, according to one or more embodiments. In one or more embodiments, operations of the professional social network system may involve selecting between a first area and a second area. Further, operations of the professional social network system may involve displaying a registration component to register a member account. Still further, operations of the professional social network system may involve accepting input through the registration component. Also, operations of the professional social network system may involve validating the input through an attestation component and registering the member through the registration component.

In an example embodiment, a professional social network may be divided into a regular area and a clone area. In the regular area every user's details may be real details of the user. The details may be validated by a validation component thus calling details real. In the clone area users may change identity and/or username. Users may know that the area being accessed is the clone area and identities revealed may not be real. The clone area may be a way of letting private details of an individual stay private. Further, the clone area acts may still allow the users to take benefits of the professional social network system whilst still keeping the identity of the users private.

In an example embodiment, a problem solved by the clone area may be that it provides professionals such as physicians a platform wherein they can freely communicate with other physicians in an environment that is exclusive to them only and not to public at large. Being able to communicate with other individuals from the same area such as in the case of physicians may provide many incentives such as physicians can communicate and share information and multimedia material on for example open heart surgery. Hence physicians may communicate freely without the fear of a person saying that the person was traumatized by viewing the communication and/or that the person relied upon the communication as medical advice.

Thus, the professional social network system may act as a platform for professionals from various domains and/or professions with other from their own domains and/or professions or other professions.

Choice features 116 may further include creation of detailed professional directory. The detailed professional directory may be created based on input provided to the registration component 110. Further, the detailed professional directory may be searchable making it easier for the users of the professional social network to use the detailed professional directory.

Choice features 116 may further include an option for users to continue education courses that may be certified by the professional social network system.

Choice features 116 may further allow professionals to post classifieds and/or advertisements that may be viewable professionals same profession as of the posting professional if the posting professional wants it to be only viewable by professionals of their own profession. So for example, if an attorney has a legal practice for sale, the attorney may want to post that practice for other attorneys to see and not a physician or a veterinarian for example and this is where the professional social network may be unique and distinguished from other classifieds sites—it provides a source where the attorney can post only to another attorney and not to the public at large. Thus, where for example an existing client of the attorney would not see advertisement and question the attorney about it. Another choice feature 116 may to post advertisements for the general user of the professional social network at large. For example the attorney may for instance post the attorney's vehicle for sale in a way that will allow all of the users of the professional social network to see the advertisement.

Professional social network may also include choice features 116 wherein users may be allowed to select type of professional users would like to have users' posting accessible to.

In an example embodiment, users may access one of a professional forum and/or a social forum. Once the users access a category such as social forum, the users are directed to an index wherein the users may post their views on. Further, professional and social forums are searchable through a search tool offered as a part of the user interface 114.

In an example embodiment, a professional social network may include a a clone site wherein members of the professional social network are unaware of identities of other members of the professional social network and a member site, wherein the members of the professional social network are aware of the identities of other members. One or more processors and a memory may be communicatively couple to the professional social network.

Further, the professional social network may include one or more programs, wherein the one or more programs are stored in the memory and configured to be executed by the one or more processors. The programs may include instructions for setting up digitized conferences amongst members of the professional social network. The digitized conferences may be one of a one to one interaction, one to many interaction, and a many to many interaction between members of the professional network. The digitized conference may also involve interaction between a non-member of the professional social network and member(s) of the professional social network.

In another example embodiment, one or more programs of the professional social network may include instructions for tracking expenditure of members of the professional social network. The instructions for tracking expenditure may account for expenses of members of the professional social network. The expenses of the members may be tracked from one of credit/debit card expenditure of members and entries of expenditure by members made into an accounting module of the professional social network.

In another example embodiment, one or more programs of the professional social network may include instructions for offering data back up over a super node/cloud. Members of the professional social network may back up data over the cloud associated with the professional social network.

In another example embodiment, one or more programs of the professional social network may include instructions for selling and buying articles amongst members of the professional social network. Members may offer to sell one of articles, and/or services over the professional social network. Professional social network may include a classified advertisement module. The members interested in selling/buying access the classified advertisement module. The classified advertisement module may be communicatively coupled to the professional social network.

In another example embodiment, one or more programs of the professional social network may include instructions for setting up financial transactions. The financial transactions may include one of financing, collaborating and member to member transactions. Financing, collaborating and member to member transactions may be facilitated through a bank payment gateway coupled to the professional social network.

A member of the professional social network may finance another member(s) of the professional social network. Further, members of the professional social network may collaborate and fund projects through the bank payment gateway.

In another example embodiment, one or more programs of the professional social network may include instructions for creating forums for members of the professional social network from one of same profession and different profession. Members of the professional social network may create forums based on topics of personal and/or professional interest.

In another example embodiment, one or more programs of the professional social network may include instructions facilitating electronic mail. Electronic mail may include an attachment of up to 250 megabytes.

In another example embodiment, one or more programs of the professional social network may include instructions for creating a discussion forum. The discussion forum may be one of general, topic specific and decided by a member of the social network with administrator privilege.

In another example embodiment, one or more programs of the professional social network may include instructions for creating groups members of the professional social network.

In another example embodiment, one or more programs of the professional social network may include instructions for searching a member directory. The member directory may include a listing of the members of the professional social network.

In another example embodiment, one or more programs of the professional social network may include instructions for sharing multimedia between the members of the professional social network. The multimedia may be one of an audio file, video file, link to multimedia on websites and/or image.

In another example embodiment, one or more programs of the professional social network may include instructions for offering educational courses and facilitating conduction of educational courses.

In another example embodiment, one or more programs of the professional social network may include instructions for creating member accounts of professional social network with special privileges, wherein the special privileges are one of anonymous posting of messages on the member site, moderating discussion forums and offering opinions with concealed identity.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A professional social network system comprising:
one or more processors;
memory; and
one or more programs, wherein the one or more programs are stored in the memory and configured to be executed by the one or more processors, the programs including:
instructions for selecting between a first area and a second area;
instructions for displaying a registration component to register a member account;
instructions for accepting input through an attestation component, wherein identity validation for the member account is provided;
instructions for validating the identity component provided through the attestation component; and
instructions for registering a member through a registration component.

2. The professional social network of claim 1, wherein the first area is a real identity area and the second area is an anonymous user area.

3. The professional social network of claim 1, wherein the verification component accesses at least one website hosted at a server through a computer network to verify the identity validation.

4. The professional social network of claim 1, wherein the programs further including:
instructions to create discussion platforms;
instructions to include new member accounts;

5. The professional social network of claim 1, wherein the programs further including:
instructions to create discussion platforms by accepting inputs from member accounts.

6. The professional social network of claim 1, wherein the programs further including:
instructions for adding an another member account, wherein the another member account is created without identity validation.

7. A computer-implemented method of a professional social network system comprising:
selecting between a first area and a second area;
displaying a registration component to register a member account;
accepting input through an attestation component, wherein identity validation for the member account is provided;
validating the identity component provided through the attestation component; and
registering a member through the registration component;

8. The computer-implemented method of claim 7, wherein the first area is a real identity area and the second area is an anonymous user area.

9. The computer-implemented method of claim 7, wherein the verification component accesses at least one website hosted at a server through a computer network to verify the identity validation.

10. The computer-implemented method of claim 7, wherein the programs further include:
instructions to create discussion platforms;
instructions to include new member accounts;

11. The computer-implemented method of claim 7, wherein the programs further include:
instructions to create discussion platforms by accepting inputs from member accounts.

12. The computer-implemented method of claim 7, wherein the programs further include:
instructions for adding an another member account, wherein the another member account is created without identity validation.

13. A professional social network comprising:
a clone site,
wherein members of the professional social network are unaware of identities of
other members of the professional social network;
a member site,
wherein the members of the professional social network are aware of the identities of other members;
one or more processors;
memory; and
one or more programs, wherein the one or more programs are stored in the memory and configured to be executed by the one or more processors, the programs including:
instructions for setting up digitized conferences amongst members of the professional social network;
instructions for tracking expenditure of members of the professional social network;
instructions for offering data back up over a super node;
instructions for selling and buying articles amongst members of the professional social network;
instructions for setting up financial transactions,
wherein the financial transactions include financing, collaborating and member to member transactions;
instructions for creating forums for member of the professional social network from one of same profession and different profession;
instructions for facilitating electronic mail;

14. The professional social network of claim 13, wherein the programs further including:
instructions for facilitating electronic mail of up to 250 megabytes between members of the professional social network;

15. The professional social network of claim 13, wherein the programs further including:
instructions for creating a discussion forum,
wherein the forum is one general, topic specific and decided by a member of the social network with administrator privilege.

16. The professional social network of claim 13, wherein the programs further including:
instructions for creating groups of member of members of the professional social network.

17. The professional social network of claim 13, wherein the programs further including:
instructions for searching a member directory,
wherein the member directory is a listing of the members of the professional social network.

18. The professional social network of claim 13, wherein the programs further including:
instructions for sharing multimedia between the members of the professional social network.

19. The professional social network of claim 13, wherein the programs further including:
instructions for:
offering educational courses; and
facilitating conduction of educational courses.

20. The professional social network of claim 13, wherein the programs further including:
instructions for creating member accounts of professional social network with special privileges, wherein the special privileges are at least one of anonymous posting of messages on the member site, moderating discussion forums and offering opinions with concealed identity.
